(19) United States
(12) Patent Application Publication
(10) Pub. No.: US 2020/0201096 A1
(43) Pub. Date: Jun. 25, 2020

(54) LIQUID CRYSTAL DISPLAY PANEL AND DRIVING METHOD THEREOF

(71) Applicant: WUHAN CHINA STAR OPTOELECTRONICS TECHNOLOGY CO., LTD., Wuhan, Hubei (CN)

(72) Inventors: Kaiwen XUE, Wuhan, Hubei (CN); Gonghua ZOU, Wuhan, Hubei (CN)

(21) Appl. No.: 16/476,087

(22) PCT Filed: Feb. 20, 2019
(86) PCT No.: PCT/CN2019/075618

§ 371 Date: Jul. 4, 2019

(30) Foreign Application Priority Data
Dec. 19, 2018 (CN) 201811558268.1

(51) Int. Cl. G02F 1/1368; G09G 3/36; G02F 1/1333; G02F 1/1362

(52) U.S. Cl. CPC G02F 1/1368; G09G 3/3677; G02F 2201/123; G02F 1/13338; G02F 1/136286; G09G 3/3688

(57) ABSTRACT

Provided are a LCD panel and a driving method thereof. The LCD panel includes pixels, scanning lines and input modules. In one of any two adjacent frame periods, the first switching unit connects the first end thereof to the second end thereof to connect the non-inverting end of the operational amplifier to the corresponding scanning line, and the second switching unit connects the third end thereof to the second end thereof to connect the inverting end of the operational amplifier to the output end. In the other of any two adjacent frame periods, the first switching unit connects the first end thereof to the third end thereof to connect the inverting end of the operational amplifier to the corresponding scanning line, and the second switching unit connects the third end thereof to the first end thereof to connect the non-inverting end of the operational amplifier to the output end.

### FIELD OF THE INVENTION

The present invention relates to a display technology field, and more particularly to a liquid crystal display panel and a driving method thereof.

### BACKGROUND OF THE INVENTION

In the display skill field, the Liquid Crystal Display (LCD) and other panel displays have been gradually replaced the Cathode Ray Tube (CRT) displays. A liquid crystal display possesses advantages of being ultra thin, power saved and radiation free and has been widely utilized.

Most of the liquid crystal displays on the present market are back light type liquid crystal display devices, which comprise a liquid crystal display panel and a back light module. Generally, the liquid crystal display panel comprises a Color Filter (CF) substrate, a Thin Film Transistor (TFT) substrate, Liquid Crystal (LC) sandwiched between the CF substrate and the TFT substrate and sealant. The working principle of the liquid crystal display panel is to locate liquid crystal molecules between two parallel glass substrates, and a plurality of vertical and horizontal tiny electrical wires are between the two glass substrates. The light of back light module is reflected to generate images by applying driving voltages to control whether the liquid crystal molecules to be changed directions.

In the prior art, each pixel of the liquid crystal display device has a thin film transistor of which a gate is coupled to a horizontal scanning line and a drain is coupled to a vertical data line. If a positive voltage is applied to a certain scanning line, the thin film transistor coupled to the scanning line is activated, so that the data voltage on the data line can be inputted into the pixel activated by the thin film transistor to control various liquid crystal transmittances and display effect.

Please refer to FIG. 1. The liquid crystal display panel of the prior art includes a plurality of pixels 100, a plurality of scanning lines 200, a plurality of input modules 300, the plurality of data lines 400 and a substrate 500. The plurality of pixels 100, the plurality of scanning lines 200, the plurality of input modules 300 and the plurality of data lines 400 are all disposed on the substrate 500. Each of the pixels 100 is correspondingly coupled to one of the input modules 300. The input module 300 corresponding to each row of pixels 100 is correspondingly coupled to one of the scanning lines 200. Each column of the pixels 100 is correspondingly coupled to one of the data lines 400. Each of the pixels 100 includes a thin film transistor T10 and a pixel electrode 110. A source of the thin film transistor T10 is electrically coupled to the data line 400 corresponding to the pixel 100 where the thin film transistor is located, and a drain of the thin film transistor is electrically coupled to the pixel electrode 110. The input module 300 includes an operational amplifier 310. The non-inverting input end of the operational amplifier 310 is electrically coupled to the corresponding scanning line 200, and the output end is electrically coupled to the gate of the thin film transistor T10 of the corresponding pixel 100, and the inverting input end is electrically coupled to the output end. Each operational amplifier 310 has an offset voltage. After the output end is shorted to the inverting input end, the difference between the voltage inputted to the non-inverting input end and the voltage outputted from the output end is the offset voltage. The offset voltages of the operational amplifiers 310 in the different input modules 300 may be different, which may cause that after the scanning signals transmitted by the scanning lines 200 are outputted to different pixels 100 through different operational amplifiers 310, the voltages actually received by the gates of the thin film transistors T10 in the different pixels 100 are different, resulting in inconsistent activated degrees of the thin film transistors T10 in the different pixels 100, so that the chargings of the respective pixels 100 are inconsistent, thereby affecting the display effect of the liquid crystal display panel.

### SUMMARY OF THE INVENTION

An objective of the present invention is to provide a liquid crystal display panel, which can compensate for display unevenness caused by different activated degrees of thin film transistors in different pixels to improve display effect.

Another objective of the present invention is to provide a driving method of a liquid crystal display panel, which can compensate for display unevenness caused by different activated degrees of thin film transistors in different pixels to improve display effect.

For realizing the aforesaid objectives, the present invention first provides a liquid crystal display panel, including a plurality of pixels arranged in an array, a plurality of scanning lines and a plurality of input modules;

wherein each of the pixels is correspondingly coupled to one of the input modules; the input module corresponding to each row of pixels is electrically coupled to one of the scanning lines; each of the pixels includes a thin film transistor; each of the input modules includes an operational amplifier, a first switching unit and a second switching unit; a control end of the first switching unit is coupled to a first control signal, and a first end of the first switching unit is electrically coupled to the scanning line corresponding to the input module where the first switching unit is located, and a second end of the first switching unit is electrically coupled to a non-inverting input end of the operational amplifier, and a third end of the first switching unit is electrically coupled to an inverting input end of the operational amplifier; a control end of the second switching unit is coupled to a second control signal, and a first end of the second switching unit is electrically coupled to the non-inverting input end of the operational amplifier, and a second end of the second switching unit is electrically coupled to the inverting input end of the operational amplifier, and a third end of the second switching unit is electrically coupled to an output of the operational amplifier; the output end of the operational amplifier is electrically coupled to a gate of the thin film transistor of the pixel corresponding to the input module where the operational amplifier is located;

wherein in one of any two adjacent frame periods, the first control signal controls the first switching unit to connect the first end of the first switching unit to the second end of the first switching unit, and the second control signal controls the second switching unit to connect the third end of the second switching unit to the second end of the second switching unit, and in an other of any two adjacent frame periods, the first control signal controls the first switching unit to connect the first end of the first switching unit to the third end of the first switching unit, and the second control signal controls the second switching unit to connect the third end of the second switching unit to the first end of the second switching unit.

The liquid crystal display panel further includes a plurality of data lines; wherein each column of the pixels is correspondingly coupled to one of the data lines.

Each of the pixels further includes a pixel electrode; a source of the thin film transistor is electrically coupled to the data line corresponding to the pixel where the thin film transistor is located, and a drain of the thin film transistor is electrically coupled to the pixel electrode.

The first switching unit is a first single-pole double-throw switch, and the control end, the first end, the second end and the third end of the first switching unit are respectively a control end, a static contact, a first moving contact and a second moving contact of the first single-pole double-throw switch;

the second switching unit is a second single-pole double-throw switch, and the control end, the first end, the second end and the third end of the second switching unit are respectively a control end, a first moving contact, a second moving contact and a static contact of the second single-pole double-throw switch.

In an odd frame period, the first control signal controls the first switching unit to connect the first end of the first switching unit to the second end of the first switching unit, and the second control signal controls the second switching unit to connect the third end of the second switching unit to the second end of the second switching unit, and in an even frame period, the first control signal controls the first switching unit to connect the first end of the first switching unit to the third end of the first switching unit, and the second control signal controls the second switching unit to connect the third end of the second switching unit to the first end of the second switching unit.

The present invention further provides a driving method of a liquid crystal display panel, comprising steps of:

Step S1, providing the liquid crystal display panel;

wherein the liquid crystal display panel includes a plurality of pixels arranged in an array, a plurality of scanning lines and a plurality of input modules;

wherein each of the pixels is correspondingly coupled to one of the input modules; the input module corresponding to each row of pixels is correspondingly coupled to one of the scanning lines; each of the pixels includes a thin film transistor; each of the input modules includes an operational amplifier, a first switching unit and a second switching unit; a control end of the first switching unit is coupled to a first control signal, and a first end of the first switching unit is electrically coupled to the scanning line corresponding to the input module where the first switching unit is located, and a second end of the first switching unit is electrically coupled to a non-inverting input end of the operational amplifier, and a third end of the first switching unit is electrically coupled to an inverting input end of the operational amplifier; a control end of the second switching unit is coupled to a second control signal, and a first end of the second switching unit is electrically coupled to the non-inverting input end of the operational amplifier, and a second end of the second switching unit is electrically coupled to the inverting input end of the operational amplifier, and a third end of the second switching unit is electrically coupled to an output of the operational amplifier; the output end of the operational amplifier is electrically coupled to a gate of the thin film transistor of the pixel corresponding to the input module where the operational amplifier is located;

Step S2, entering a frame period;

wherein the first control signal controls the first switching unit to connect the first end of the first switching unit to the second end of the first switching unit, and the second control signal controls the second switching unit to connect the third end of the second switching unit to the second end of the second switching unit; and

Step S3, entering an other frame period adjacent to the frame period in Step S2;

wherein the first control signal controls the first switching unit to connect the first end of the first switching unit to the third end of the first switching unit, and the second control signal controls the second switching unit to connect the third end of the second switching unit to the first end of the second switching unit.

The liquid crystal display panel further includes a plurality of data lines; wherein each column of the pixels is correspondingly coupled to one of the data lines.

Each of the pixels further includes a pixel electrode; a source of the thin film transistor is electrically coupled to the data line corresponding to the pixel where the thin film transistor is located, and a drain of the thin film transistor is electrically coupled to the pixel electrode.

The first switching unit is a first single-pole double-throw switch, and the control end, the first end, the second end and the third end of the first switching unit are respectively a control end, a static contact, a first moving contact and a second moving contact of the first single-pole double-throw switch;

the second switching unit is a second single-pole double-throw switch, and the control end, the first end, the second end and the third end of the second switching unit are respectively a control end, a first moving contact, a second moving contact and a static contact of the second single-pole double-throw switch.

The one frame period in Step S2 is an odd frame period, and the other frame period in Step S3 is an even frame period adjacent to the odd frame period in Step S2.

The benefits of the present invention are: The liquid crystal display panel includes a plurality of pixels arranged in an array, a plurality of scanning lines and a plurality of input modules. In one of any two adjacent frame periods, the first switching unit of the input module connects the first end thereof to the second end thereof to connect the non-inverting end of the operational amplifier to the corresponding scanning line, and the second switching unit connects the third end thereof to the second end thereof to connect the inverting end of the operational amplifier to the output end. In the other of any two adjacent frame periods, the first switching unit of the input module connects the first end thereof to the third end thereof to connect the inverting end of the operational amplifier to the corresponding scanning line, and the second switching unit connects the third end thereof to the first end thereof to connect the non-inverting end of the operational amplifier to the output end. Thus, it can compensate for display unevenness caused by different activated degrees of thin film transistors in different pixels to improve display effect. The driving method of the liquid crystal display panel according to the present invention can compensate for display unevenness caused by different activated degrees of thin film transistors in different pixels to improve display effect.

### BRIEF DESCRIPTION OF THE DRAWINGS

In order to better understand the characteristics and technical aspect of the invention, please refer to the following detailed description and accompanying drawings of the present invention. However, the drawings are provided for reference only and are not intended to be limiting of the invention.

In drawings,

FIG. 1 is a structural diagram of a liquid crystal display panel according to the prior art;

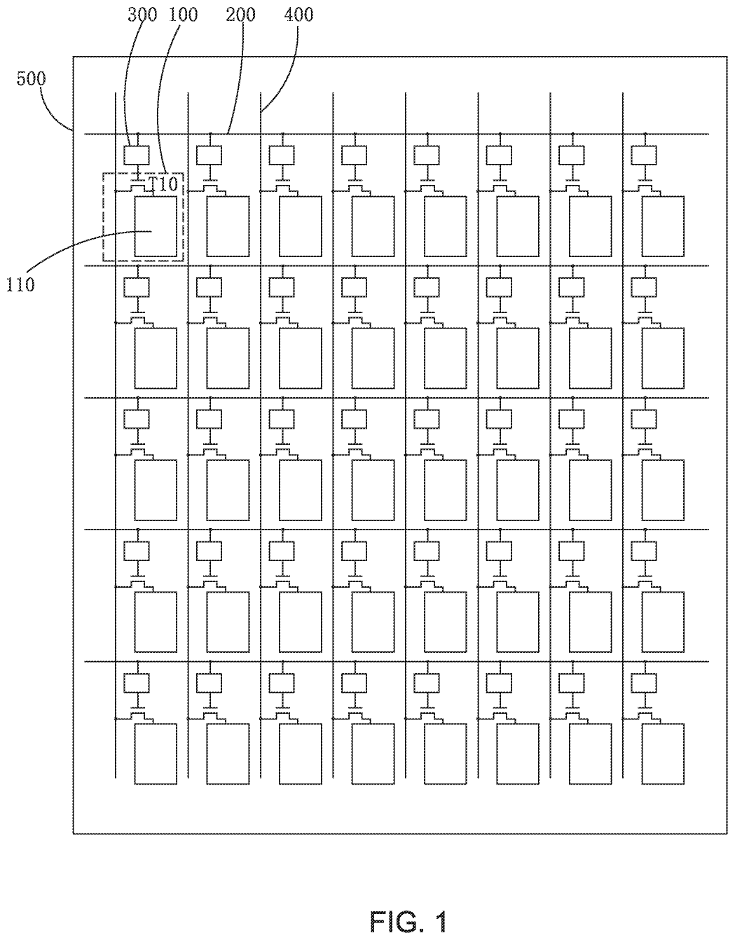

FIG. 2 is a connection diagram of an input module, a scanning line and a pixel of a liquid crystal display panel according to the prior art;

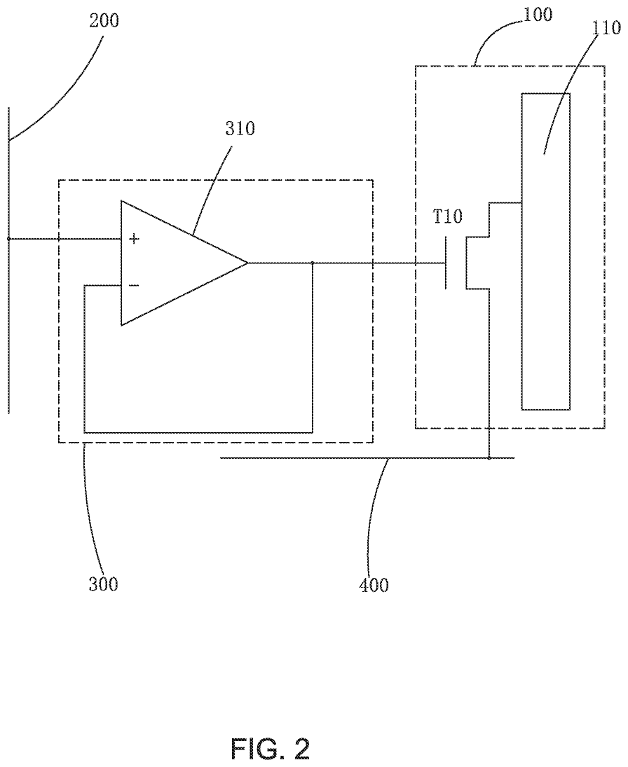

FIG. 3 is a structure diagram of a liquid crystal display panel of the present invention;

FIG. 4 is a connection diagram of an input module, a scanning line and a pixel of a liquid crystal display panel according to the present invention;

FIG. 5 is a flow chart of a driving method of a liquid crystal display panel of the present invention;

FIG. 6 is a diagram of Step S2 of a driving method of a liquid crystal display panel of the present invention;

FIG. 7 is a diagram of Step S3 of a driving method of a liquid crystal display panel of the present invention.

### DETAILED DESCRIPTION OF PREFERRED EMBODIMENTS

For better explaining the technical solution and the effect of the present invention, the present invention will be further described in detail with the accompanying drawings and the specific embodiments.

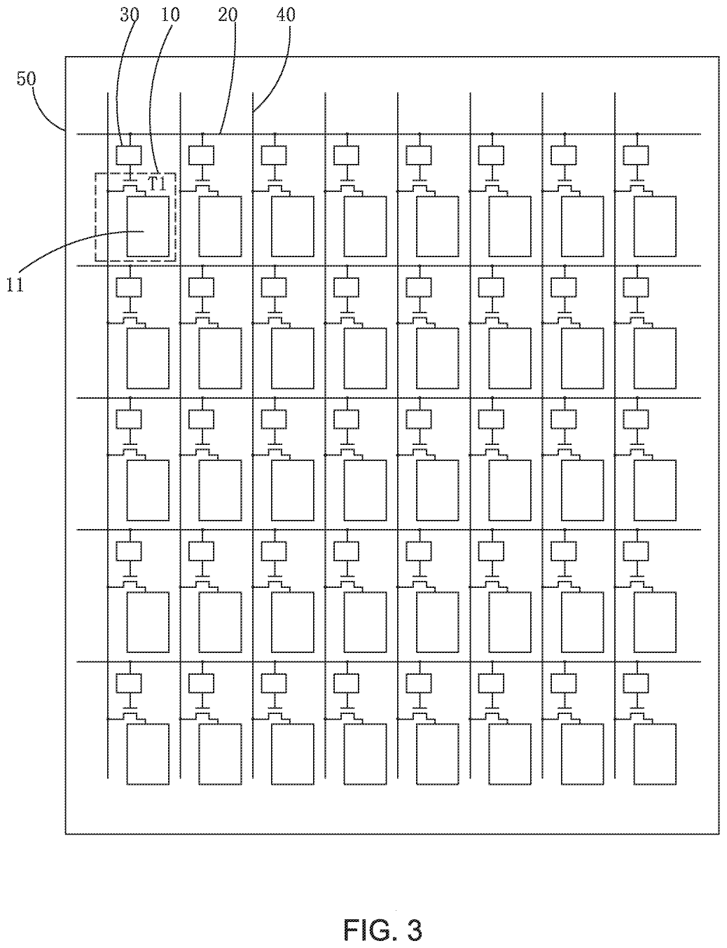

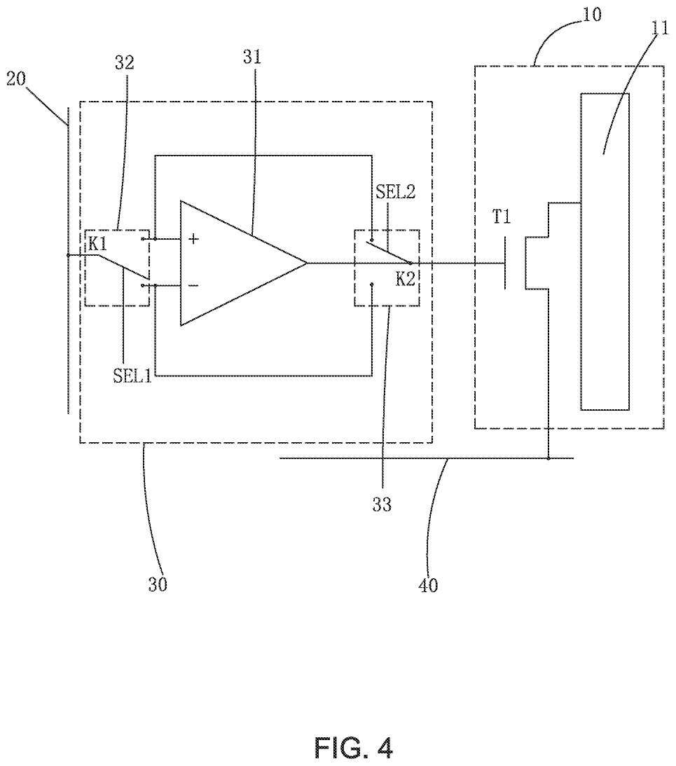

Please refer to FIG. 3 and FIG. 4. The present invention provides a liquid crystal display panel, including a plurality of pixels 10 arranged in an array, a plurality of scanning lines 20, a plurality of input modules 30, a plurality of data lines 40 and a substrate 50. The plurality of pixels 10, the plurality of scanning lines 20, the plurality of input modules 30 and the plurality of data lines 40 are all disposed on the substrate 50.

wherein each of the pixels is correspondingly coupled to one of the input modules; The input module 30 corresponding to each row of pixels 10 is correspondingly coupled to one of the scanning lines 20. Each column of the pixels 10 is correspondingly coupled to one of the data lines 40. Each of the pixels 10 includes a thin film transistor T1 and a pixel electrode 11. Each of the input modules 30 includes an operational amplifier 31, a first switching unit 32 and a second switching unit 33. A control end of the first switching unit 32 is coupled to a first control signal SEL1, and a first end of the first switching unit is electrically coupled to the scanning line 20 corresponding to the input module 30 where the first switching unit is located, and a second end of the first switching unit is electrically coupled to a non-inverting input end of the operational amplifier 31, and a third end of the first switching unit is electrically coupled to an inverting input end of the operational amplifier 31. A control end of the second switching unit 33 is coupled to a second control signal SEL2, and a first end of the second switching unit is electrically coupled to the non-inverting input end of the operational amplifier 31, and a second end of the second switching unit is electrically coupled to the inverting input end of the operational amplifier 31, and a third end of the second switching unit is electrically coupled to an output of the operational amplifier 31. The output end of the operational amplifier 31 is electrically coupled to a gate of the thin film transistor T1 of the pixel 10 corresponding to the input module 30 where the operational amplifier is located. A source of the thin film transistor T1 is electrically coupled to the data line 40 corresponding to the pixel 10 where the thin film transistor is located, and a drain of the thin film transistor is electrically coupled to the pixel electrode 11.

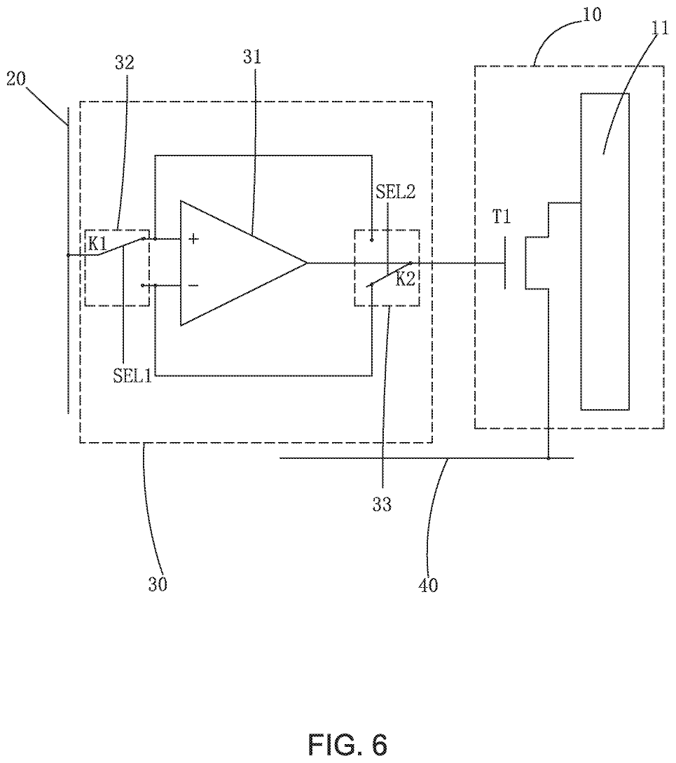

Specifically, in one of any two adjacent frame periods, please refer to FIG. 6, the first control signal SEL1 controls the first switching unit 32 to connect the first end thereof to the second end thereof to connect the non-inverting end of the operational amplifier 31 to the corresponding scanning line 20, and the second control signal SEL2 controls the second switching unit 33 to connect the third end thereof to the first end thereof to connect the inverting end of the operational amplifier 31 to the output end. Then, since the operational amplifier 31 has an offset voltage, as the scanning line 20 transmits the scanning signal to the non-inverting input end of the operational amplifier 31 and is outputted to the gate of the thin film transistor T1 of the corresponding pixel 10 via the output end of the operational amplifier 31, the voltage value outputted by the scanning line 20 is greater than the voltage value received by the thin film transistor T1 of the corresponding pixel 10 and the difference is the offset voltage of the operational amplifier 31. In the other of any two adjacent frame periods. the first control signal SEL1 controls the first switching unit 32 to connect the first end thereof to the third end thereof to connect the inverting end of the operational amplifier 31 to the corresponding scanning line 20, and the second control signal SEL2 controls the second switching unit 33 to connect the third end thereof to the first end thereof to connect the non-inverting end of the operational amplifier 31 to the output end. Then, since the operational amplifier 31 has an offset voltage, as the scanning line 20 transmits the scanning signal to the non-inverting input end of the operational amplifier 31 and is outputted to the gate of the thin film transistor T1 of the corresponding pixel 10 via the output end of the operational amplifier 31, the voltage value outputted by the scanning line 20 is less than the voltage value received by the thin film transistor T1 of the corresponding pixel 10 and the difference is the offset voltage of the operational amplifier 31. Thus, the voltage value received by the gate of the thin film transistor T1 of the same pixel 10 in the adjacent two frame periods respectively correspond to the offset voltage of the operational amplifier 31 with the high voltage value outputted by corresponding scanning line 20 and the offset voltage of the operational amplifier 31 with the low voltage value. The voltage values received by the gate of the thin film transistor T1 of the same pixel 10 in the adjacent two frame periods are mutually compensated. Even if the offset voltages of the operational amplifiers 31 corresponding to the different pixels 10 are different, the compensation of the adjacent two frames can compensate for the display unevenness caused by the inconsistency in the activated degrees of the thin film transistors T1 of the respective pixels 10 with utilization of the visual delay effect of the human eye.

Preferably, the first switching unit 32 is a first single-pole double-throw switch K1, and the control end, the first end, the second end and the third end of the first switching unit 32 are respectively a control end, a static contact, a first moving contact and a second moving contact of the first single-pole double-throw switch K1. The second switching unit 33 is a second single-pole double-throw switch K2, and the control end, the first end, the second end and the third end of the second switching unit 33 are respectively a control end, a first moving contact, a second moving contact and a static contact of the second single-pole double-throw switch K2.

Preferably, in an odd frame period, the first control signal SEL1 controls the first switching unit 32 to connect the first end of the first switching unit to the second end of the first switching unit, and the second control signal SEL2 controls the second switching unit 33 to connect the third end of the second switching unit to the second end of the second switching unit, and in an even frame period, the first control signal SEL1 controls the first switching unit 32 to connect the first end of the first switching unit to the third end of the first switching unit, and the second control signal SEL2 controls the second switching unit 33 to connect the third end of the second switching unit to the first end of the second switching unit.

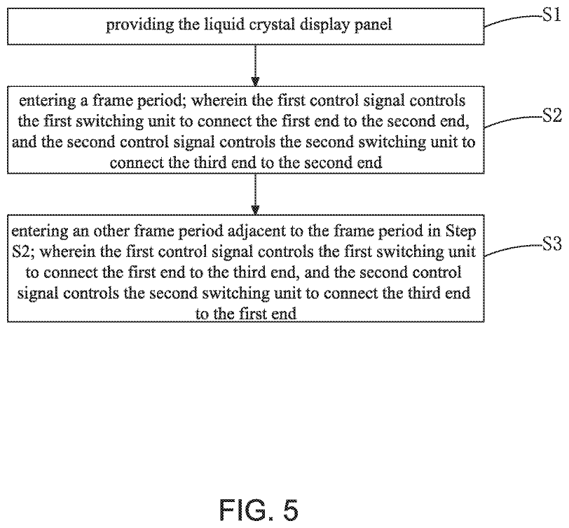

On the basis of the same inventive idea, referring to FIG. 5, the present invention further provides a driving method of a liquid crystal display panel, including:

Step S1, providing the liquid crystal display panel.

The liquid crystal display panel includes a plurality of pixels 10 arranged in an array, a plurality of scanning lines 20, a plurality of input modules 30, a plurality of data lines 40 and a substrate 50. The plurality of pixels 10, the plurality of scanning lines 20, the plurality of input modules 30 and the plurality of data lines 40 are all disposed on the substrate 50.

Each of the pixels 10 is correspondingly coupled to one of the input modules 30. The input module 30 corresponding to each row of pixels 10 is correspondingly coupled to one of the scanning lines 20. Each column of the pixels 10 is correspondingly coupled to one of the data lines 40. Each of the pixels 10 includes a thin film transistor T1 and a pixel electrode 11. Each of the input modules 30 includes an operational amplifier 31, a first switching unit 32 and a second switching unit 33. A control end of the first switching unit 32 is coupled to a first control signal SEL1, and a first end of the first switching unit is electrically coupled to the scanning line 20 corresponding to the input module 30 where the first switching unit is located, and a second end of the first switching unit is electrically coupled to a non-inverting input end of the operational amplifier 31, and a third end of the first switching unit is electrically coupled to an inverting input end of the operational amplifier 31. A control end of the second switching unit 33 is coupled to a second control signal SEL2, and a first end of the second switching unit is electrically coupled to the non-inverting input end of the operational amplifier 31, and a second end of the second switching unit is electrically coupled to the inverting input end of the operational amplifier 31, and a third end of the second switching unit is electrically coupled to an output of the operational amplifier 31. The output end of the operational amplifier 31 is electrically coupled to a gate of the thin film transistor T1 of the pixel 10 corresponding to the input module 30 where the operational amplifier is located. A source of the thin film transistor T1 is electrically coupled to the data line 40 corresponding to the pixel 10 where the thin film transistor is located, and a drain of the thin film transistor is electrically coupled to the pixel electrode 11.

Preferably, the first switching unit 32 is a first single-pole double-throw switch K1, and the control end, the first end, the second end and the third end of the first switching unit 32 are respectively a control end, a static contact, a first moving contact and a second moving contact of the first single-pole double-throw switch K1.

The second switching unit 33 is a second single-pole double-throw switch K2, and the control end, the first end, the second end and the third end of the second switching unit 33 are respectively a control end, a first moving contact, a second moving contact and a static contact of the second single-pole double-throw switch K2.

Step S2, entering one frame period, wherein the plurality of scanning lines 20 sequentially transmit scanning signals to the input modules 30 corresponding to the plurality of rows of pixels 10.

Please refer to FIG. 6, the first control signal SEL1 controls the first switching unit 32 to connect the first end thereof to the second end thereof to connect the non-inverting end of the operational amplifier 31 to the corresponding scanning line 20, and the second control signal SEL2 controls the second switching unit 33 to connect the third end thereof to the first end thereof to connect the inverting end of the operational amplifier 31 to the output end. Then, since the operational amplifier 31 has an offset voltage, as the scanning line 20 transmits the scanning signal to the non-inverting input end of the operational amplifier 31 and is outputted to the gate of the thin film transistor T1 of the corresponding pixel 10 via the output end of the operational amplifier 31, the voltage value outputted by the scanning line 20 is greater than the voltage value received by the thin film transistor T1 of the corresponding pixel 10 and the difference is the offset voltage of the operational amplifier 31.

The one frame period in Step S2 is an odd frame period.

Step S3, entering an other frame period adjacent to the frame period in Step S2, wherein the plurality of scanning lines 20 sequentially transmit scanning signals to the input modules 30 corresponding to the plurality of rows of pixels 10.

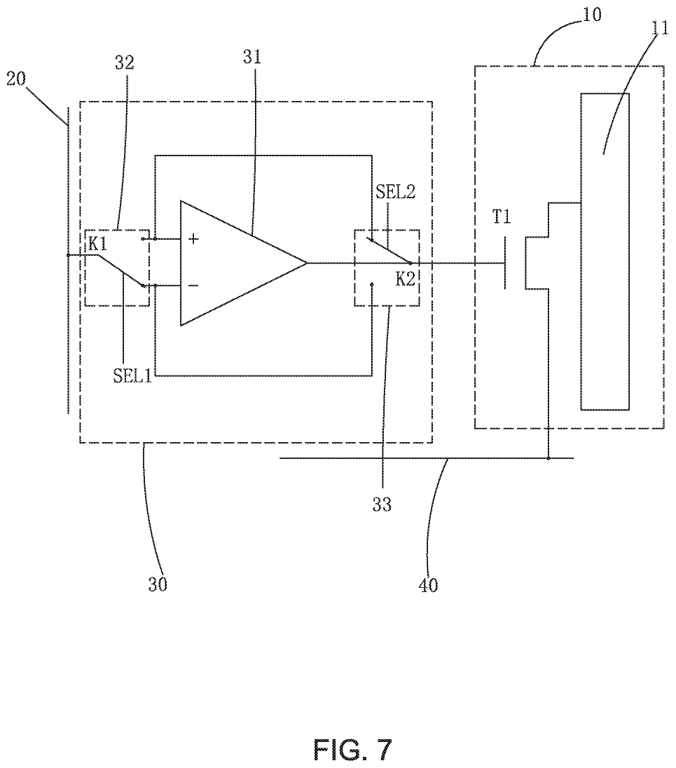

Please refer to FIG. 7, the first control signal SEL1 controls the first switching unit 32 to connect the first end thereof to the third end thereof to connect the inverting end of the operational amplifier 31 to the corresponding scanning line 20, and the second control signal SEL2 controls the second switching unit 33 to connect the third end thereof to the first end thereof to connect the non-inverting end of the operational amplifier 31 to the output end. Then, since the operational amplifier 31 has an offset voltage, as the scanning line 20 transmits the scanning signal to the non-inverting input end of the operational amplifier 31 and is outputted to the gate of the thin film transistor T1 of the corresponding pixel 10 via the output end of the operational amplifier 31, the voltage value outputted by the scanning line 20 is less than the voltage value received by the thin film transistor T1 of the corresponding pixel 10 and the difference is the offset voltage of the operational amplifier 31. Thus, the voltage value received by the gate of the thin film transistor T1 of the same pixel 10 in the adjacent two frame periods respectively correspond to the offset voltage of the operational amplifier 31 with the high voltage value outputted by corresponding scanning line 20 and the offset voltage of the operational amplifier 31 with the low voltage value. The voltage values received by the gate of the thin film transistor T1 of the same pixel 10 in the adjacent two frame periods are mutually compensated. Even if the offset voltages of the operational amplifiers 31 corresponding to the different pixels 10 are different, the compensation of the adjacent two frames can compensate for the display unevenness caused by the inconsistency in the activated degrees of the thin film transistors T1 of the respective pixels 10 with utilization of the visual delay effect of the human eye.

Preferably, the other frame period in Step S3 is an even frame period adjacent to the odd frame period in Step S2.

In conclusion, the liquid crystal display panel of the present invention includes a plurality of pixels arranged in an array, a plurality of scanning lines and a plurality of input modules. In one of any two adjacent frame periods, the first switching unit of the input module connects the first end thereof to the second end thereof to connect the non-inverting end of the operational amplifier to the corresponding scanning line, and the second switching unit connects the third end thereof to the second end thereof to connect the inverting end of the operational amplifier to the output end. In the other of any two adjacent frame periods, the first switching unit of the input module connects the first end thereof to the third end thereof to connect the inverting end of the operational amplifier to the corresponding scanning line, and the second switching unit connects the third end thereof to the first end thereof to connect the non-inverting end of the operational amplifier to the output end. Thus, it can compensate for display unevenness caused by different activated degrees of thin film transistors in different pixels to improve display effect. The driving method of the liquid crystal display panel according to the present invention can compensate for display unevenness caused by different activated degrees of thin film transistors in different pixels to improve display effect.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A liquid crystal display panel, including a plurality of pixels arranged in an array, a plurality of scanning lines and a plurality of input modules;
wherein each of the pixels is correspondingly coupled to one of the input modules; the input module corresponding to each row of pixels is electrically coupled to one of the scanning lines; each of the pixels includes a thin film transistor; each of the input modules includes an operational amplifier, a first switching unit and a second switching unit; a control end of the first switching unit is coupled to a first control signal, and a first end of the first switching unit is electrically coupled to the scanning line corresponding to the input module where the first switching unit is located, and a second end of the first switching unit is electrically coupled to a non-inverting input end of the operational amplifier, and a third end of the first switching unit is electrically coupled to an inverting input end of the operational amplifier; a control end of the second switching unit is coupled to a second control signal, and a first end of the second switching unit is electrically coupled to the non-inverting input end of the operational amplifier, and a second end of the second switching unit is electrically coupled to the inverting input end of the operational amplifier, and a third end of the second switching unit is electrically coupled to an output of the operational amplifier; the output end of the operational amplifier is electrically coupled to a gate of the thin film transistor of the pixel corresponding to the input module where the operational amplifier is located;
wherein in one of any two adjacent frame periods, the first control signal controls the first switching unit to connect the first end of the first switching unit to the second end of the first switching unit, and the second control signal controls the second switching unit to connect the third end of the second switching unit to the second end of the second switching unit, and in an other of any two adjacent frame periods, the first control signal controls the first switching unit to connect the first end of the first switching unit to the third end of the first switching unit, and the second control signal controls the second switching unit to connect the third end of the second switching unit to the first end of the second switching unit.

2. The liquid crystal display panel according to claim 1, further including a plurality of data lines; wherein each column of the pixels is correspondingly coupled to one of the data lines.

3. The liquid crystal display panel according to claim 2, wherein each of the pixels further includes a pixel electrode; a source of the thin film transistor is electrically coupled to the data line corresponding to the pixel where the thin film transistor is located, and a drain of the thin film transistor is electrically coupled to the pixel electrode.

4. The liquid crystal display panel according to claim 1, wherein the first switching unit is a first single-pole double-throw switch, and the control end, the first end, the second end and the third end of the first switching unit are respectively a control end, a static contact, a first moving contact and a second moving contact of the first single-pole double-throw switch;
the second switching unit is a second single-pole double-throw switch, and the control end, the first end, the second end and the third end of the second switching unit are respectively a control end, a first moving contact, a second moving contact and a static contact of the second single-pole double-throw switch.

5. The liquid crystal display panel according to claim 1, wherein in an odd frame period, the first control signal controls the first switching unit to connect the first end of the first switching unit to the second end of the first switching unit, and the second control signal controls the second switching unit to connect the third end of the second switching unit to the second end of the second switching unit, and in an even frame period, the first control signal controls the first switching unit to connect the first end of the first switching unit to the third end of the first switching unit, and the second control signal controls the second switching unit to connect the third end of the second switching unit to the first end of the second switching unit.

6. A driving method of a liquid crystal display panel, including:
Step S1, providing the liquid crystal display panel;
wherein the liquid crystal display panel includes a plurality of pixels arranged in an array, a plurality of scanning lines and a plurality of input modules;
wherein each of the pixels is correspondingly coupled to one of the input modules; the input module corresponding to each row of pixels is correspondingly coupled to one of the scanning lines; each of the pixels includes a thin film transistor; each of the input modules includes an operational amplifier, a first switching unit and a second switching unit; a control end of the first switching unit is coupled to a first control signal, and a first end of the first switching unit is electrically coupled to the scanning line corresponding to the input module where the first switching unit is located, and a second end of the first switching unit is electrically coupled to a non-inverting input end of the operational amplifier, and a third end of the first switching unit is electrically coupled to an inverting input end of the operational amplifier; a control end of the second switching unit is coupled to a second control signal, and a first end of the second switching unit is electrically coupled to the non-inverting input end of the operational amplifier, and a second end of the second switching unit is electrically coupled to the inverting input end of the operational amplifier, and a third end of the second switching unit is electrically coupled to an output of the operational amplifier; the output end of the operational amplifier is electrically coupled to a gate of the thin film transistor of the pixel corresponding to the input module where the operational amplifier is located;
Step S2, entering a frame period;
wherein the first control signal controls the first switching unit to connect the first end of the first switching unit to the second end of the first switching unit, and the second control signal controls the second switching unit to connect the third end of the second switching unit to the second end of the second switching unit; and
Step S3, entering an other frame period adjacent to the frame period in Step S2;
wherein the first control signal controls the first switching unit to connect the first end of the first switching unit to the third end of the first switching unit, and the second control signal controls the second switching unit to connect the third end of the second switching unit to the first end of the second switching unit.

7. The driving method of the liquid crystal display panel according to claim 6, wherein the liquid crystal display panel further includes a plurality of data lines; wherein each column of the pixels is correspondingly coupled to one of the data lines.

8. The driving method of the liquid crystal display panel according to claim 7, wherein each of the pixels further includes a pixel electrode; a source of the thin film transistor is electrically coupled to the data line corresponding to the pixel where the thin film transistor is located, and a drain of the thin film transistor is electrically coupled to the pixel electrode.

9. The driving method of the liquid crystal display panel according to claim 6, wherein the first switching unit is a first single-pole double-throw switch, and the control end, the first end, the second end and the third end of the first switching unit are respectively a control end, a static contact, a first moving contact and a second moving contact of the first single-pole double-throw switch;
the second switching unit is a second single-pole double-throw switch, and the control end, the first end, the second end and the third end of the second switching unit are respectively a control end, a first moving contact, a second moving contact and a static contact of the second single-pole double-throw switch.

10. The driving method of the liquid crystal display panel according to claim 6. wherein the one frame period in Step S2 is an odd frame period, and the other frame period in Step S3 is an even frame period adjacent to the odd frame period in Step S2.
